(19) United States
(12) Patent Application Publication
(10) Pub. No.: US 2024/0009983 A1
(43) Pub. Date: Jan. 11, 2024

(54) PLATE MATERIAL AND METHOD FOR PRODUCING THE PLATE MATERIAL

(71) Applicant: Profol GmbH, Halfing (DE)

(72) Inventor: Udo Steinhauer, Halfing (DE)

(21) Appl. No.: 17/857,642

(22) Filed: Jul. 5, 2022

(51) Int. Cl. B32B 37/06; B32B 5/12; B32B 7/08; B32B 27/08; B32B 27/06; B32B 27/32; B32B 5/02; B32B 5/18; B32B 5/24; B32B 5/26

(52) U.S. Cl. CPC B32B 37/06; B32B 5/12; B32B 7/08; B32B 27/08; B32B 27/065; B32B 27/32; B32B 5/022; B32B 5/18; B32B 5/245; B32B 5/26; B32B 2250/04; B32B 2250/242; B32B 2250/40; B32B 2260/021; B32B 2260/046; B32B 2307/546; B32B 2307/54; B32B 2307/732; B32B 2307/516; B32B 2323/10

(57) ABSTRACT

A plate material comprising a first tape layer comprising a group of fibers unidirectionally oriented in a first direction and disposed in a matrix of a plastic material; a second tape layer comprising a group of fibers unidirectionally oriented in a second direction perpendicular to the first direction and disposed in a matrix of the plastic material; a foam layer comprising a foam of the plastic material; a third tape layer comprising a group of fibers unidirectionally oriented in a third direction and disposed in a matrix of the plastic material; and a fourth tape layer comprising a group of fibers unidirectionally oriented in a fourth direction perpendicular to the third direction and disposed in a matrix of the plastic material.

### TECHNICAL FIELD

The present invention relates to a plate material that is ultra-light and has a high-strength. Furthermore, the invention relates to a manufacturing method of a plate material.

### PRIOR ART

In the field of plate materials, sandwich panels are known to consist of several layers. In most cases, the sandwich panels are made up of two thin cover layers and a core or mounting element in between.

One aspect of plate materials is to make them particularly lightweight. Another aspect of plate materials is to achieve an excellent ratio of weight to mechanical strength.

Known plate materials have honeycomb structured cores as mounting elements. These honeycomb structured cores have the disadvantage that they do not have a homogeneous surface and no isotropic stability. Thus, the cover layer cannot be bonded to the honeycomb structured core over the entire surface. In addition, the honeycomb structured core has a different strength depending on the load direction.

Furthermore, known plate materials are not sustainable and no reuse or recycling is possible.

### SUMMARY

There is a need to provide a plate material that has high strength and a low weight. In addition, the plate material should be sustainable, and recycling should be possible.

The problems and needs mentioned above are solved by the objects of the independent claims. Further advantageous embodiments of the present invention are indicated in the dependent claims.

One idea of the invention is to combine a plate material with four tape layers, wherein unidirectional fibers of the tape layers in adjacent tape layers are each aligned perpendicular to each other.

The invention relates to a plate material that is ultra-light and has high strength.

For this purpose, the plate material comprises a first tape layer comprising a group of fibers unidirectionally oriented in a first direction and disposed in a matrix of a plastic material; a second tape layer comprising a group of fibers unidirectionally oriented in a second direction perpendicular to the first direction and disposed in a matrix of the plastic material; a foam layer comprising a foam of the plastic material; a third tape layer comprising a group of fibers unidirectionally oriented in a third direction and disposed in a matrix of the plastic material; and a fourth tape layer comprising a group of fibers unidirectionally oriented in a fourth direction perpendicular to the third direction and disposed in a matrix of the plastic material.

Unidirectional means that the fibers are all oriented parallel within a tape layer.

The plate material is reduced in weight through the use of a foam core. By combining the foam core with unidirectional tape layers with fibers in a plastic material matrix, high bending strength and tensile strength are achieved. The different orientation of the fibers in adjacent tape layers of the plate material increases the strength of the plate material. The plate material has an excellent ratio of weight to mechanical strength or stiffness. The plate material can be recycled due to the use of a uniform plastic material. For example, the plate material can be chopped, regranulated and the matrix content adjusted in a recycling process. Then, the pellets can be used for a subsequent injection molding application, such as long fiber reinforced thermoplastic (LFRTs) applications. Furthermore, the plate material can be produced more easily.

According to one embodiment, the third tape layer is arranged at least partially over the fourth tape layer; the foam layer is arranged at least partially over the third tape layer; the second tape layer is arranged at least partially over the foam layer; and the first tape layer is arranged at least partially over the second tape layer. Thus, a bond can be formed between the tape layers and the foam layer. By arranging the layers one above the other, a two-dimensional bond (laminate) can be produced and thus a higher strength can be achieved.

According to one embodiment, the third tape layer and the fourth tape layer at least partially overlap; the foam layer and the third tape layer at least partially overlap; the second tape layer and the foam layer at least partially overlap; the first tape layer and the second tape layer at least partially overlap. Preferably, the first through fourth tape layers and the foam layer overlap completely. The overlap allows the tape layers and the foam layer to be bonded over a largest possible area so that the strength, especially the bending strength, of the plate material is increased.

According to another embodiment of the present invention, the plastic material of the matrix and foam is polypropylene and/or the fibers of at least one of the first to fourth tape layers consist of glass fibers, basalt fibers or natural fibers. By using polypropylene in the tape layers and the foam layer, the plate material is uniformly composed of polypropylene, making the plate material sustainable and recyclable.

For example, the plastic material may be a polypropylene (PP). The plastic material may have no fillers. Another component of the plastic material may be an adhesion promoter. For example, the bonding agent may comprise a polypropylene functionalized with cyclic carboxylic anhydride, and in particular, the bonding agent may comprise a maleic anhydride grafted polypropylene. The bonding agent may comprise stabilizers and/or colors. Preferably, the bonding agent may comprise a maleic anhydride grafted polypropylene and stabilizers.

At least one of the first to fourth tape layers may have a layer thickness of 0.15 mm to 0.25 mm, preferably a layer thickness of 0.2 mm (200 μm).

The matrix of the first tape layer may be made of the same plastic material (e.g., same composition) as the matrix of the second tape layer. The matrix of the third tape layer may be made of the same plastic material as the fourth tape layer. The matrix of the first to fourth tape layers may be made of the same plastic material. The plastic material of the matrix may be a thermoplastic plastic. Preferably, the plastic material of the matrix of the first to fourth tape layers is polypropylene. By using polypropylene in the first through fourth tape layers, a sustainable plate material is produced. The plate material may be a single grade plastic.

The fibers in at least one of the first through fourth tape layers may be glass fibers, carbon fibers, natural fibers (e.g., cellulose fibers), or basalt fibers. Preferably, the fibers of at least one of the first through fourth tape layers are glass fibers. Particularly preferably, the fibers of the first through fourth tape layers comprise glass fibers. The use of fibers in the tape layer can improve the strength of each of the tape layers. The group of fibers allow for better stability of the tape layers. In addition, the strength of the plate material can be increased by the fibers.

The use of glass fibers is cost-effective, so a low-cost plate material with improved strength can be produced. The glass fibers may be made of commercial electro-glass (so-called E-glass). The density of the glass fiber may be 2.62 g/cm³.

The number of the group of fibers in the first tape layer and fourth tape layer may be higher than the number of the group of fibers in the second tape layer and third tape layer. The first tape layer and/or the fourth tape layer may have a glass fiber content of 60% to 75% (m/m). Preferably, the first and/or fourth tape layer may have a glass fiber content of 72%. The second tape layer and/or the third tape layer may have a glass fiber content of 60% to 75% (m/m). Preferably, the second and/or the third tape layer may have a glass fiber content of 66%. Alternatively, the first to fourth tape layers may have equal glass fiber content. Alternatively, the glass fiber content in the second and third tape layers may be equal. A fiber diameter may be between 15 μm and 20 μm, preferably 17 μm.

The plastic material of the foam layer may correspond to the plastic material of the matrix of at least one of the first through fourth tape layers. The plastic material of the foam layer may be polypropylene. Preferably, the foam layer may be conventional polypropylene, such as that used in the automotive and floor impact sound insulation fields. The foam layer may be polypropylene foam, which is excellent spatially isotropic. The foam layer may not contain filler gases. The thickness of the foam layer may be 2 mm to 15 mm, preferably 5 mm to 10 mm. The density of the foam layer may be 0.1 g/cm³ to 0.4 g/cm³. The foam layer may be arranged as a finished layer between the tape layers.

The use of a foam core makes it possible to integrate mounting elements directly into the plate element, to achieve a much higher and isotropic stability and to provide the plate material with a homogeneous surface. Thus, a plate material with improved strength can be provided.

By using polypropylene in the first through fourth tape layers and the foam layer, the plate material consists of a single monomaterial plastic polypropylene, making the plate material fully recyclable. Preferably, the plate material of polypropylene can be fully recycled into long fiber reinforced thermoplastic (LFRTs) material. Thus, the plate material is sustainable.

According to one embodiment, the fourth direction corresponds to the first direction and the third direction corresponds to the second direction. By arranging the fibers in adjacent tape layers rotated by 90°, the strength of the plate material is increased. For example, the first direction may be rotated relative to the second direction by a value in a range of 80° to 100°. The direction of the group of fibers in the first tape layer may cross the direction of the group of fibers in the second tape layer, so that the strength of the composite of the first tape layer and the second tape layer is increased. By combining the foam layer with two tape layers on the top and bottom, the strength of the plate material can be increased.

According to one embodiment, the plate material further comprises a fifth tape layer. The fifth tape layer may be a polypropylene film. Alternatively, the fifth tape layer may comprise a polypropylene film with a lacquer layer or a polypropylene film with a decorative layer. Thus, the plate material can be directly bonded to a film, varnish layer, or decorative layer easily and inexpensively.

Preferably, the first to fourth tape layers are bonded to each other and to the foam layer without an adhesive. Preferably, the first to fourth tape layers and the foam layer are bonded to each other by welding (e.g. thermal lamination).

The term welding is understood to mean the permanent bonding of the tape layers and the foam layer together by increasing temperature and/or increasing pressure. One form of welding is thermal lamination of plastics for the present disclosure.

Thermal lamination means that the tape layers are bonded to each other and to the foam layer by temperature increase and/or pressure increase in a planar and adhesive-free manner and a detachment of the layers cannot be done non-destructively. In particular, thermal lamination means that the first to fourth tape layers and the foam layer of thermoplastic material are permanently bonded to each other without adhesives by increasing the temperature and/or pressure.

In accordance with one embodiment of the present invention, a method of producing a plate material is provided. The method comprises the steps of: providing a first tape layer comprising a group of fibers unidirectionally oriented in a first direction and disposed in a matrix of a plastic material; providing a second tape layer comprising a group of fibers unidirectionally oriented in a second direction perpendicular to the first direction and disposed in a matrix of the plastic material; providing a foam layer comprising a foam of the plastic material; providing a third tape layer comprising a group of fibers unidirectionally oriented in a third direction and disposed in a matrix of the plastic material; providing a fourth tape layer comprising a group of fibers unidirectionally oriented in a fourth direction perpendicular to the third direction and disposed in a matrix of the plastic material; arranging the first tape layer at least partially over the second tape layer; arranging the second tape layer at least partially over the foam layer; arranging the third tape layer at least partially under the foam layer; arranging the fourth tape layer at least partially under the third tape layer; welding the first tape layer to the second tape layer and the second tape layer to the foam layer; welding the fourth tape layer to the third tape layer and the third tape layer to the foam layer.

Thus, an ultralight and high-strength plate material can be produced easily and inexpensively by continuous welding (e.g. thermal lamination) of the fiber-reinforced tape layers to the foam core in a single production line.

The method for producing plate material is suitable for producing the plate material according to the invention.

According to one embodiment, in the method, the step of welding the first tape layer to the second tape layer and the second tape layer to the foam layer; and the step of welding the fourth tape layer to the third tape layer and the third tape layer to the foam layer may be performed simultaneously. Thus, the plate material can be produced more quickly and at a lower cost.

According to one embodiment, the first to fourth tape layers are endless tape layers. An endless tape layer is a tape layer provided from a roll. In particular, the first to fourth tape layer may be provided from a roll. This allows the plate material to be produced quickly and easily within a production line.

According to one embodiment, the plastic material of the matrix and the plastic material of the foam comprises polypropylene. Alternatively or additionally, the fibers may be glass fibers, natural fibers or basalt fibers. Thus, a high-strength, ultra-lightweight and sustainably produced plate material can be produced.

According to one embodiment, the method further comprises the steps of providing a fifth tape layer; arranging the fifth tape layer at least partially over the first tape layer; and welding the fifth tape layer to the first tape layer. For example, the fifth tape layer may comprise a polypropylene film. Alternatively, the polypropylene film may be a polypropylene film with a lacquer layer or a polypropylene film with a decorative layer. Thus, the plate material can be easily and inexpensively produced and finished within a production line.

### BRIEF DESCRIPTION OF THE DRAWINGS

The embodiments of the present invention will be explained and clarified in particular in the context of the following figures. In this connection, the scope of protection is not intended to be limited to this embodiment, and the figures and the accompanying description accordingly serve only to clarify the general ideas of the invention.

FIG. 1 illustrates a schematic structure of the first embodiment of the invention.

FIG. 2 illustrates a schematic structure of the second embodiment of the invention.

FIG. 3 illustrates a photograph of a section of a tape layer of an embodiment according to the invention with glass fibers in a polypropylene matrix.

FIG. 4 illustrates a photograph of a section of two thermally laminated tape layers of an embodiment of the invention according to the invention

### DETAILED DESCRIPTION

The embodiments are to be understood as exemplary, and not restrictive, so that individual features of the embodiments are also used to characterize the invention. Furthermore, modifications of the embodiment described below may each be individually combined to form further embodiments of the invention.

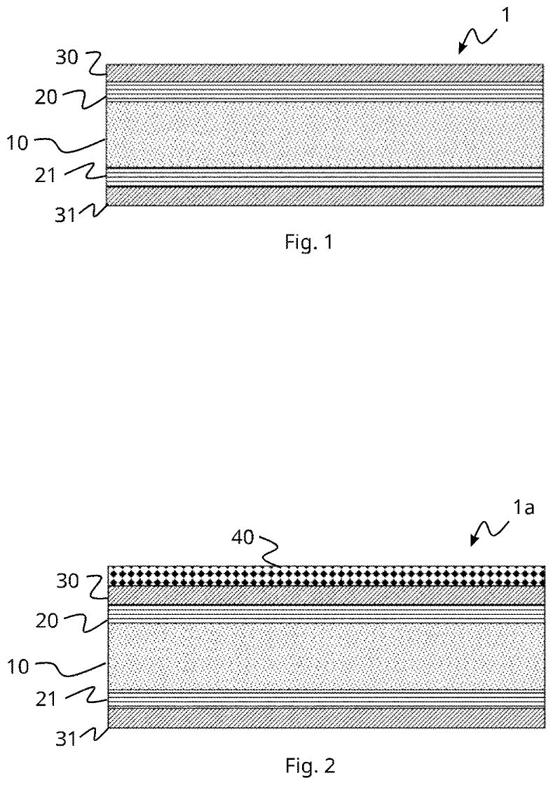

FIG. 1 illustrates a plate material 1 of a first embodiment, the structure of which is described in more detail with reference to FIG. 1.

The plate material 1 comprises a first tape layer 30 comprising a group of fibers unidirectionally oriented in a first direction. The fibers of the first tape layer 30 are disposed in a matrix of plastic material. Preferably, glass fibers are disposed in a matrix of polypropylene. The plate material 1 has a second tape layer 20 comprising a group of fibers unidirectionally oriented in a second direction perpendicular to the first direction. The group of fibers of the second tape layer 20 are disposed in a matrix of polypropylene. The second tape layer 20 is thermally laminated to the first tape layer 30. The plate material further comprises a foam layer 10 comprising a foam of polypropylene. The plate material 1 further comprises a third tape layer 21, the third tape layer 21 again comprising a group of fibers unidirectionally oriented in a third direction and disposed in a matrix of polypropylene. The plate material 1 further comprises a fourth tape layer 31 comprising a group of fibers unidirectionally oriented in a fourth direction perpendicular to the third direction and disposed in a matrix of polypropylene. The second tape layer 20 is thermally laminated to the first tape layer 30 and the foam layer 10. The third tape layer 21 is thermally laminated to the fourth tape layer 31 and the foam layer 10. Thus, the layers of plate material 1 are laminated to each other.

The foam layer 10 has an isotropic strength and thus a higher stability. In addition, the foam layer 10 has a homogeneous surface. The composition of the polypropylene of the foam layer may vary to the composition of the polypropylene of the first to fourth tape layers 30, 20, 21, 31. In further embodiments, the composition of the polypropylene may vary between layers of the plate material 1. The first to fourth tape layers 30, 20, 21, 31 may each be an endless tape.

The first tape layer 30, as well as the fourth tape layer 31, is a unidirectional tape with a glass fiber content of 60% to 80% in a polypropylene matrix, the fibers being oriented in the machine direction. Preferably, the glass fiber content of the first tape layer 30 and the fourth tape layer 31 may be 72%. The second tape layer 20, as well as the third tape layer 21, is a unidirectional tape with a glass fiber content of 60% to 80% in a polypropylene matrix, the fibers being oriented transverse to the machine direction. Preferably, the glass fiber content of the second tape layer 20 and the third tape layer 21 may be 66%. Within a tape layer, all fibers are oriented parallel to each other. The layer thickness of each of the first to fourth tape layers 30, 20, 21, 31 is 200 μm. The layer thickness of the foam layer 10 varies between 2 mm and 15 mm. Preferably, the layer thickness of the foam layer 10 is 5 mm to 10 mm with a density of 0.1 g/cm³ to 0.4 g/cm³. The fiber diameter is 17 μm within a tape layer.

The polypropylene plastic may have a bonding agent (or adhesion promoter). The bonding agent may comprise a polypropylene functionalized with cyclic carboxylic acid anhydride. Alternatively, the plastic material of the plate material 1 may comprise a thermoplastic material other than polypropylene.

In the preferred embodiment, the plate material 1 comprises a foam core 10 and unidirectional tapes 30, 20, 21, 31 (so-called UD tapes) thermally laminated thereon on the upper and lower surfaces.

The plate material 1a of the second embodiment differs from the plate material 1 of the first embodiment in that a further polypropylene film 40 is arranged on the first tape layer. Alternatively, the polypropylene film 40 may comprise a polypropylene film with a lacquer film or a polypropylene film with a decorative film arranged on the first tape layer 30. The polypropylene film 40 is applied to the side of the first tape layer 30 facing an outer side of the plate material. As shown in FIG. 2, the plate material has an additional polypropylene film 40 on the first tape layer 30. The plate material of FIG. 2 is constructed as described in the first embodiment.

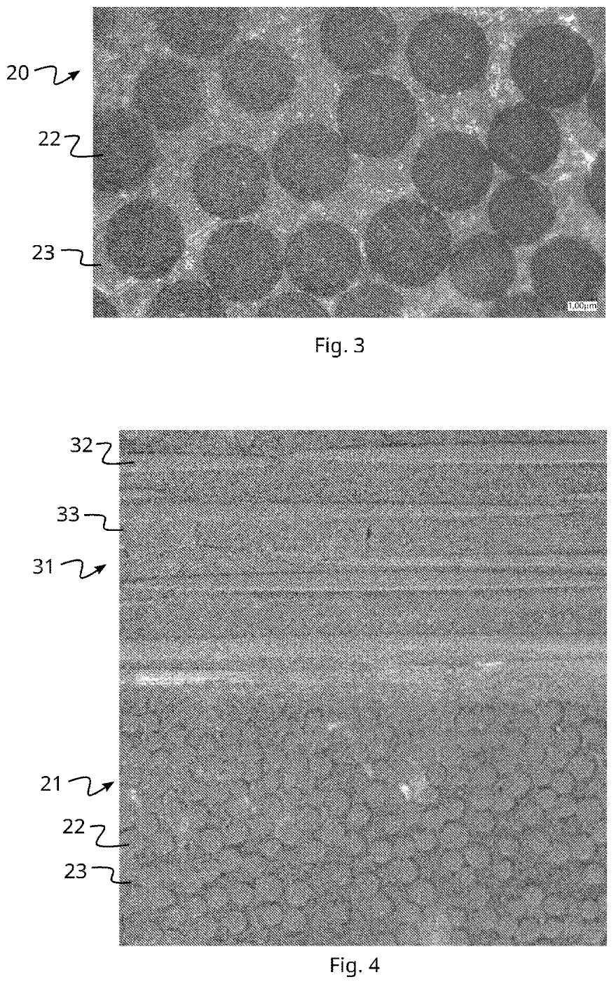

FIG. 3 illustrates a photograph of a section of a tape layer 20 of an embodiment according to the invention with glass fibers 22 in a polypropylene matrix 23. Within the tape layer 20, as well as in the further tape layers, 30, 21, 31, the glass fibers are completely enclosed by a polypropylene matrix. The glass fibers 22 are shown in cross-section in FIG. 3, each completely enclosed by the polypropylene matrix. Here, the number of the fibers within a tape layer 20 may vary in some areas, so that the thickness of the polypropylene matrix 23 may vary between adjacent glass fibers 22. The glass fibers 22 are all oriented and arranged in the same manner.

FIG. 4 shows a photograph of a section of two thermally laminated tape layers 31, 21 of an embodiment of the invention according to the present invention. The orientation of the fibers 32, 22 is different between the third tape layer 21 and the fourth tape layer 31. The fibers 32 of the fourth tape layer 31 have been cut longitudinally in FIG. 4. Between the glass fibers 32 of the fourth tape layer 31 is the polypropylene matrix 33. In contrast, the fibers 22 of the third tape layer 21 have been cut in cross-section in FIG. 4. The polypropylene matrix 23 of the third tape layer 21 is located between the glass fibers 22 of the third tape layer 21. FIG. 4 shows that the fiber direction of the third tape layer 21 is rotated by 90° to the fiber direction of the fourth tape layer 31.

The method for producing a plate material is suitable for producing the plate material 1 of the first and second embodiments.

The process enables continuous thermal lamination of the first to fourth tape layers (so-called UD tapes) with the foam core in a double tape press.

The method comprises the steps of: Providing a first tape layer comprising a group of fibers unidirectionally oriented in a first direction and disposed in a matrix of a plastic material, and providing a second tape layer comprising a group of fibers unidirectionally oriented in a second direction perpendicular to the first direction and disposed in a matrix of the plastic material. In addition, the step of providing a foam layer comprising a foam of the plastic material is performed, preferably simultaneously, within a production line. Further, the steps of providing a third tape layer comprising a group of fibers unidirectionally oriented in a third direction and disposed in a matrix of the plastic material and providing a fourth tape layer comprising a group of fibers unidirectionally oriented in a fourth direction perpendicular to the third direction and disposed in a matrix of the plastic material are preferably performed simultaneously. The method further comprises the steps of: arranging the first tape layer at least partially over the second tape layer; arranging the second tape layer at least partially over the foam layer; arranging the third tape layer at least partially under the foam layer; and arranging the fourth tape layer at least partially under the third tape layer. Subsequently, the first tape layer is welded to the second tape layer and the second tape layer is welded to the foam layer, and the fourth tape layer is welded to the third tape layer and the third tape layer is welded to the foam layer. Preferably, the first tape layer, the second tape layer, the foam layer, the third tape layer and the fourth tape layer are welded together in one step (simultaneously). Thus, a plate material is produced that comprises several tape layers and a foam core that are welded to each other, in particular thermally laminated to each other.

Furthermore, the second tape layer and/or the third tape layer may be provided by a transverse roll in the production process. The foam layer may be provided in the process as a sheet or from a roll, depending on the stiffness of the foam core.

The bonding of the tape layers to each other and to the foam layer takes place by increasing the temperature and pressure. Thus, the plate material is thermally laminated, and no adhesive is required.

An additional polypropylene film may be applied to the plate material in the same production process via an additional unwinder onto the first tape layer 30 (so-called UD tape layer). Alternatively, a polypropylene film may be applied to the plate material with a lacquer film or a polypropylene film with a decorative film on the first tape layer 30.

Although detailed embodiments of the invention have now been described, these should only serve for a better understanding of the invention and its effects. The scope of protection is defined by the following claims and should not be limited by the detailed description.

1. A plate material comprising:
a first tape layer comprising a group of fibers unidirectionally oriented in a first direction and disposed in a matrix of a plastic material;
a second tape layer comprising a group of fibers unidirectionally oriented in a second direction perpendicular to the first direction and disposed in a matrix of the plastic material;
a foam layer comprising a foam of the plastic material;
a third tape layer comprising a group of fibers unidirectionally oriented in a third direction and disposed in a matrix of the plastic material; and
a fourth tape layer comprising a group of fibers unidirectionally oriented in a fourth direction perpendicular to the third direction and disposed in a matrix of the plastic material.

2. The plate material according to claim 1, wherein:
the third tape layer is arranged at least partially over said fourth tape layer;
the foam layer is arranged at least partially over the third tape layer;
the second tape layer is arranged at least partially over the foam layer; and
the first tape layer is arranged at least partially over the second tape layer.

3. The plate material according to claim 1, wherein:
the third tape layer and the fourth tape layer at least partially overlap;
the foam layer and the third tape layer at least partially overlap;
the second tape layer and the foam layer at least partially overlap; and
the first tape layer and the second tape layer at least partially overlap.

4. The plate material according to claim 1, wherein:
the plastic material of the matrix and the foam is a thermoplastic; and/or
the fibers of at least one of the first to fourth tape layers are glass fibers, basalt fibers or natural fibers.

5. The plate material according to claim 1, wherein:
the fourth direction corresponds to the first direction and the third direction corresponds to the second direction; and/or
the plate material further comprises a fifth tape layer.

6. A method of producing a plate material, the method comprising:
providing a first tape layer comprising a group of fibers unidirectionally oriented in a first direction and disposed in a matrix of a plastic material;
providing a second tape layer comprising a group of fibers unidirectionally oriented in a second direction perpendicular to the first direction and disposed in a matrix of the plastic material;
providing a foam layer comprising a foam of the plastic material;
providing a third tape layer comprising a group of fibers unidirectionally oriented in a third direction and disposed in a matrix of the plastic material;
providing a fourth tape layer comprising a group of fibers unidirectionally oriented in a fourth direction perpendicular to the third direction and disposed in a matrix of the plastic material;
arranging the first tape layer at least partially over the second tape layer;
arranging the second tape layer at least partially over the foam layer;
arranging the third tape layer at least partially under the foam layer;
arranging the fourth tape layer at least partially under the third tape layer;
welding the first tape layer to the second tape layer and the second tape layer to the foam layer; and
welding the fourth tape layer to the third tape layer and the third tape layer to the foam layer.

7. The method according to claim 6, wherein the welding the first tape layer to the second tape layer and the second tape layer to the foam layer, and the welding the fourth tape layer to the third tape layer and the third tape layer to the foam layer, are performed simultaneously.

8. The method according to claim 6, wherein the first tape layer and the second tape layer are endless tape layers.

9. The method of according to any claim 6, wherein:
the plastic material of the matrix and foam is a thermoplastic plastic material; and/or
the fibers are glass fibers, natural fibers or basalt fibers.

10. The method according claim 6, further comprising:
providing a fifth tape layer;
arranging the fifth tape layer at least partially over the first tape layer; and
welding the fifth tape layer to the first tape layer.

11. The plate material according to claim 1, wherein the plastic material of the matrix and the foam is a thermoplastic polypropylene.

12. The method according to claim 6, wherein the plastic material of the matrix and foam is a thermoplastic polypropylene.
